(19) United States
(12) Patent Application Publication
(10) Pub. No.: US 2019/0340643 A9
(43) Pub. Date: Nov. 7, 2019

(54) SALES PROMOTION IN ACCORDANCE WITH ELECTRONIC RECEIPT ISSUANCE

(71) Applicant: TOSHIBA TEC KABUSHIKI KAISHA, Tokyo (JP)

(72) Inventor: Tatsuya KANEKO, Mishima Shizuoka (JP)

(21) Appl. No.: 15/228,061

(22) Filed: Aug. 4, 2016

(30) Foreign Application Priority Data
Sep. 18, 2015 (JP) 2015-185313

(51) Int. Cl. G06Q 30/02; G07G 5/00

(52) U.S. Cl. CPC G06Q 30/0253; G07G 5/00; G06Q 30/0268

(57) ABSTRACT

A point-of-sale terminal includes a code reader, a communication interface, a memory device, a control panel, and a processor. The processor is configured to control the communication interface to transmit a customer code read by the code reader to an electronic receipt server, store in the memory device, a number of times electronic receipts have been issued in association with the customer code, the number of times being provided by the electronic receipt server to the communication interface, store in the memory device, transaction details based on one or more product codes read by the code reader, determine whether or not a sales promotion is to be offered based on the number of times, in response to a user input to complete the transaction on the control panel, and generate receipt information based on the transaction detail stored in the memory device and the offered sales promotion, if any.

### CROSS-REFERENCE TO RELATED APPLICATION

This application is based upon and claims the benefit of priority from Japanese Patent Application No. 2015-185313, filed Sep. 18, 2015, the entire contents of which are incorporated herein by reference.

### FIELD

Embodiments described herein relate generally to an information terminal device, an information processing device, an information processing system, and a program.

### BACKGROUND

According to a receipt system, when a transaction is carried out at a store, a paper receipt is passed at the store to a customer, or alternatively an electronic receipt is electronically transmitted to a mobile terminal of the customer. When the electronic receipt is transmitted, the customer can view the electronic receipt on a display unit of the mobile terminal.

According to such a receipt system, by issuing the electronic receipt instead of the paper receipt, it is possible for the store to reduce consumption of paper for printing the paper receipt. The receipt system is also beneficial to customers because an account book can be electrically created using the electronic receipts. However, further benefit to receive electronic receipts is desired by customers.

### DESCRIPTION OF THE DRAWINGS

FIG. 1 illustrates an electronic receipt system according to a first embodiment.

FIG. 2 is a block diagram of a POS terminal in the electronic receipt system.

FIG. 3 is a block diagram of an electronic receipt management server in the electronic receipt system.

FIG. 4 illustrates a structure of an electronic receipt region of the electronic receipt management server.

FIG. 5 is a block diagram of a customer terminal in the electronic receipt system.

FIG. 6 illustrates functional sections of a control unit of the POS terminal.

FIG. 7 is a flowchart illustrating a flow of processing carried out by the POS terminal.

FIG. 8 illustrates functional sections of a control unit of the electronic receipt management server.

FIG. 9 is a flowchart illustrating a flow of processing carried out by the electronic receipt management server.

FIG. 10 is a flowchart illustrating a flow of processing carried out by the customer terminal.

FIG. 11 is a flowchart illustrating a flow of processing carried out by a POS terminal according to a second embodiment.

FIG. 12 illustrates functional sections of a control unit of an electronic receipt management server according to the second embodiment.

FIG. 13 is a flowchart illustrating a flow of processing carried out by the electronic receipt management server according to the second embodiment.

### DETAILED DESCRIPTION

An embodiment provides an information terminal device, an information processing device, an information processing system, and a program capable of providing a scheme for customer benefit using an electronic receipt system.

In general, according to an embodiment, a point-of-sale terminal includes a code reader, a communication interface, a memory device, a control panel, and a processor. The processor is configured to control the communication interface to transmit a customer code read from a customer's medium by the code reader to an electronic receipt server, store in the memory device, a number of times electronic receipts have been issued in association with the customer code, the number of times being provided by the electronic receipt server to the communication interface, store in the memory device, transaction details based on one or more product codes read by the code reader, determine whether or not a sales promotion with respect to a transaction is offered to the customer based on the number of times, in response to a user input to complete the transaction on the control panel, and generate receipt information based on the transaction detail stored in the memory device and the offered sales promotion, if any.

According to another embodiment, an electronic receipt server includes a communication interface, a memory device, and a processor. The processor is configured to store, in the memory device, an electronic receipt in association with a customer code, upon the communication interface receiving the electronic receipt along with the customer code, increment, in an entry of a customer table associated with a customer code, a number of times electronic receipts have been issued in association with the customer code, after the communication interface receiving the electronic receipt along with the customer code, and in response to an inquiry along with the customer code, control the communication interface to return the number of times.

According to still another embodiment, an electronic receipt server includes a communication interface, a memory device, and a processor. The processor is configured to store, in the memory device, an electronic receipt in association with a customer code, upon the communication interface receiving the electronic receipt along with the customer code, increment, in an entry of a customer table associated with a customer code, a number of times electronic receipts have been issued in association with the customer code, after the communication interface receiving the electronic receipt along with the customer code, in response to an inquiry along with the customer code, determine whether or not a sales promotion is offered to a customer associated with the customer code, based on the number of times stored in the memory device in association with the customer code, and control the communication interface to return a determination result.

Hereinafter, with reference to the attached drawings, an information terminal device, an information processing device, an information processing system, and a program according to one or more embodiments will be described in detail. In first embodiment and second embodiments, a POS terminal will be described as an example of the information terminal device. In addition, an electronic receipt management server will be described as an example of the information processing device. In addition, merchandise will be described as an example of a sales target. The present disclosure is not limited to embodiments described below.

### First Embodiment

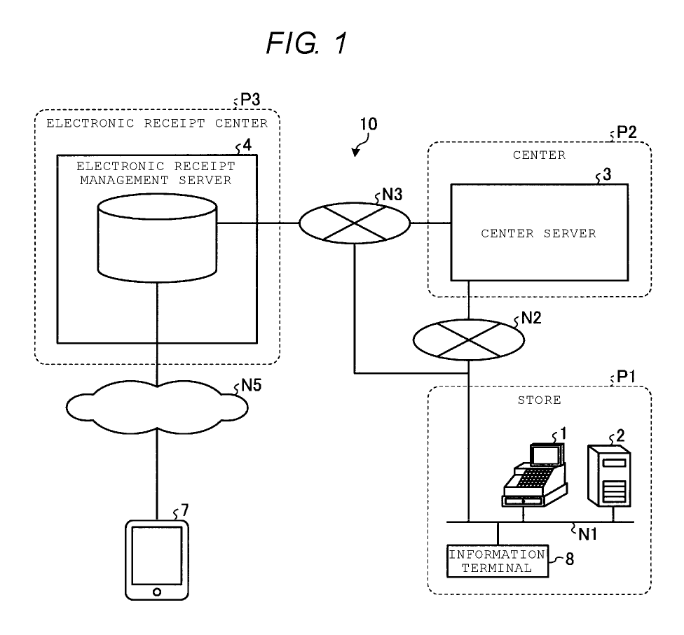

With reference to FIG. 1 to FIG. 10, the first embodiment will be described. FIG. 1 illustrates a configuration of an electronic receipt system 10 according to the first embodiment. As illustrated in FIG. 1, the electronic receipt system 10 includes a point of sales (POS) terminal 1, which is an information terminal device, a store server 2, which is a company server, a center server 3, which is a company server, an electronic receipt management server 4, which is an information processing device, and a portable terminal 7, which is a customer terminal.

The POS terminal 1 and the store server 2 are provided in the store P1, and communicably connected with each other through a network N1 in the store such as a local area network (LAN) and the like. In addition, the POS terminal 1 and the store server 2 are connected to a connection network N2 that connects the store P1 and a center P2 through a network device (not illustrated) such as a router or the like connected to the network N1 in the store. Here, for example, the network N2 is a dedicated line such as the Internet, a virtual private network (VPN), and the like.

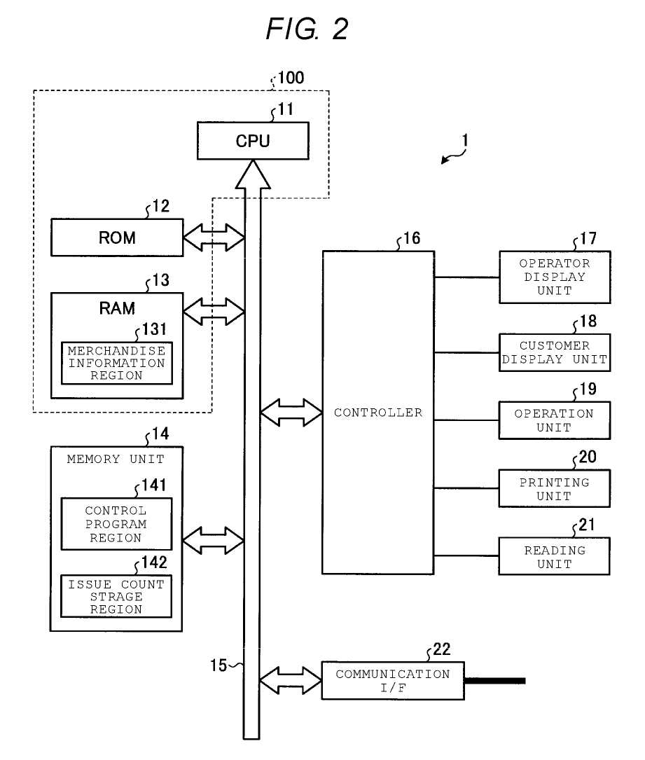

The POS terminal 1 performs sales registration processing and checkout processing with respect to merchandise sold in the store. The sales registration processing includes retrieving the name, price, or the like of the merchandise (merchandise information) from a merchandise master (not illustrated) and displaying the retrieved result, based on the code of merchandise that is input, and storing the merchandise information in a merchandise information section 131 (see FIG. 2). The checkout processing includes displaying total amount of a transaction, processing payment of the deposit amount by customer, based on the merchandise information stored through the sales registration processing. More specifically, the checkout processing includes processing for calculating and displaying the change, processing for instructing a change machine to discharge the change, processing for issuing a receipt including receipt information that is text data of a unstructured format generated from the merchandise information and payment information (total amount, deposit amount, change amount, or the like), or the like. Processing including the sales registration processing and the checkout processing are combined is referred as transaction processing.

In addition, the POS terminal 1 generates electronic receipt information by converting a data format of receipt information into a structured format, and transmits the generated electronic receipt information to the center server 3 through the network N2. In addition, the POS terminal 1 transmits the electronic receipt information to an electronic receipt management server 4 through a network N3. Without particularly limiting a transmission method of the electronic receipt information, general purpose protocol such as HTTP, HTTPS, and the like may be used. In addition, for example, the network N3 is a dedicated line such as the Internet, VPN, or the like. Here, the electronic receipt information includes a member ID or the like, which is information to specify a destination of the electronic receipt information, in addition to the merchandise information and the payment information of the transacted merchandise.

The store server 2 performs management of processing performed in the POS terminal 1, such as the transaction processing and the like. For example, the store server 2 stores and manages the merchandise information obtained through the sales registration processing by the POS terminal 1. In addition, the store server 2 stores information of the merchandise master or the like that contains the merchandise information.

In the first embodiment, the POS terminal 1 transmits the electronic receipt information to the center server 3 and the electronic receipt management server 4. However, the present disclosure is not limited thereto. For example, a data format of the receipt information generated in the POS terminal 1 may be converted, by the store server 2 and a conversion device not illustrated, into the electronic receipt information, and the generated electronic receipt information may be output to the center server 3 and the electronic receipt management server 4 may be implemented.

The center server 3 is provided in a center P2 of a company that operates the store P1, and manages various kinds of information of every member company that manages the store P1. The store P1 may be a single store or chain stores.

The center server 3 is connected to the POS terminal 1 and the store server 2 through the network N2. In addition, the center server 3 is connected to the electronic receipt management server 4 through the network N3.

The center server 3 receives various kinds of information from each of the POS terminal 1 and the store server 2 through the network N2. For example, the center server 3 has a function of performing sales management, sales analysis, inventory management, and the like of the company that operates the store P1, based on information collected from the store P1. In addition, the center server 3 receives information from the electronic receipt management server 4 through the network N3.

The electronic receipt management server 4 is provided in an electronic receipt center P3. The electronic receipt center P3 is, for example, a third party organization other than the company that manages the center server 3. The third party organization or the like may also manage the center server 3.

The electronic receipt management server 4 manages electronic receipt information issued by various companies each of which operates the store P1. The electronic receipt management server 4 stores and manages the member ID that is used to specify the destination of the electronic receipt information, such as the name and a customer code of the customer(member) who has completed the membership registration, in a membership master (not illustrated). Separately from the electronic receipt management server 4, a membership management server or the like for performing storage and management of the membership data may be provided.

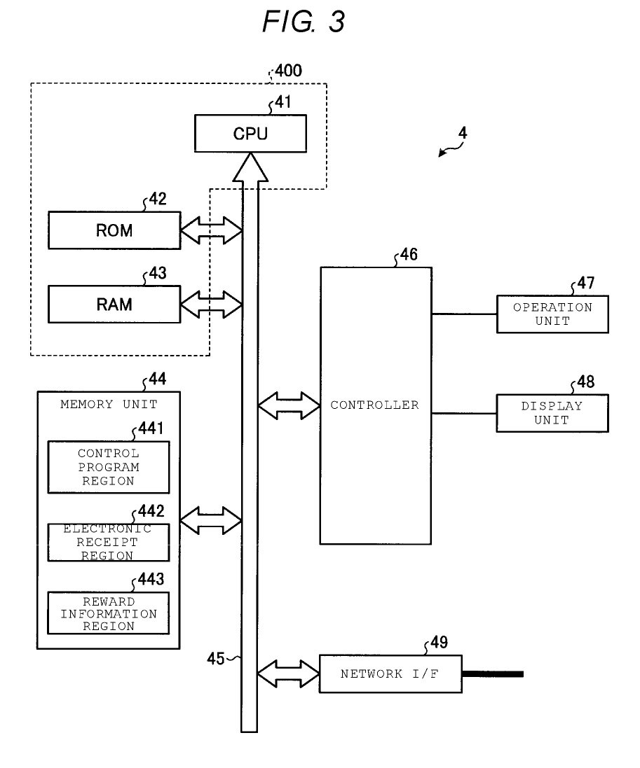

In addition, the electronic receipt management server 4 receives the electronic receipt information transmitted from the POS terminal 1 through the network N3, and stores and manages the electronic receipt information in the electronic receipt region 442 (see FIG. 3).

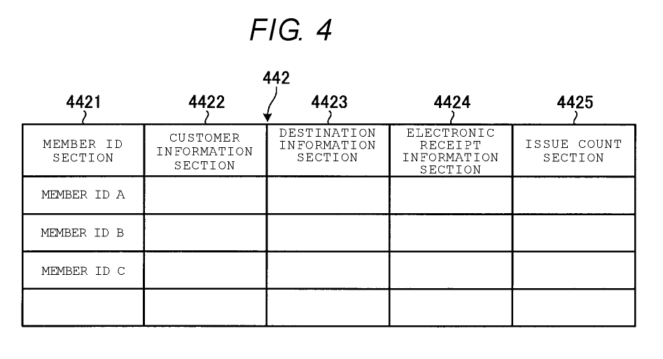

The electronic receipt management server 4 counts a number of times the electronic receipt information was transmitted from the POS terminal 1, as the number of issue times of the electronic receipt. Specifically, when the electronic receipt information is received from the POS terminal 1, the electronic receipt management server 4 stores the electronic receipt information received for every member ID in an electronic receipt information section 4424 (see FIG. 4). When the electronic receipt management server 4 receives the electronic receipt information, the electronic receipt management server 4 increases the number of issue times of electronic receipt stored in an issue count section 4425 by one. Here, the number of issue times of the electronic receipt is the number of times the electronic receipt management server 4 receives the electronic receipt information transmitted from the POS terminal 1.

In addition, the electronic receipt management server specifies the destination of the electronic receipt information by referring to destination information associated with the member ID. For example, the destination information is an address of a delivery destination of an e-mail. Then, the electronic receipt management server 4 discloses the electronic receipt information stored in the electronic receipt information section 4424 on the Web, through a network N5 described below.

In addition, when the electronic receipt management server 4 receives a view request of the electronic receipt designating a member ID from the portable terminal 7 connected through the network N5, the electronic receipt information becomes available by extracting the electronic receipt information corresponding to the member ID from the electronic receipt information section 4424 and disclosing the extracted result on the Web. Customers can view the electronic receipt information by using the portable terminal (customer terminal) 7, which has access to the destination.

The portable terminal 7 is used for a customer to view the electronic receipt information. For example, the portable terminal 7 is a terminal device such as a smart phone, a mobile phone, a personal digital assistant (PDA), a tablet computer, and the like. An application such as a web browser or the like for viewing various kinds of information provided on the Web is installed in the portable terminal 7. The customer terminal may be a PC or the like instead of the portable terminal 7. Here, the network N5 is, for example, the Internet.

The portable terminal 7 accesses the electronic receipt management server 4 through the network N5, and displays the electronic receipt information disclosed on the Web, as the electronic receipt, on a display unit. As a result, the customer can view the electronic receipt displayed on the portable terminal 7. In order to view the electronic receipt, the customer may need to complete membership registration to the electronic receipt system using the portable terminal 7.

The membership registration to the electronic receipt system may be performed through the following procedure. A customer transmits a blank e-mail from the portable terminal 7 to the electronic receipt management server 4 through the network N5. The electronic receipt management server 4 transmits a uniform resource locator (URL) to a webpage for the membership registration to a mail address from which the e-mail was received. The customer accesses the URL from the portable terminal 7 to cause an input screen for inputting information required for the membership registration (name, destination information, or the like) to be displayed on the portable terminal 7. After input of the required information, the electronic receipt management server 4 performs the membership registration with respect to the membership master. Then, the electronic receipt management server 4 delivers a membership registration completion mail including the member ID and a password to the portable terminal 7. In such a manner, the membership registration is performed.

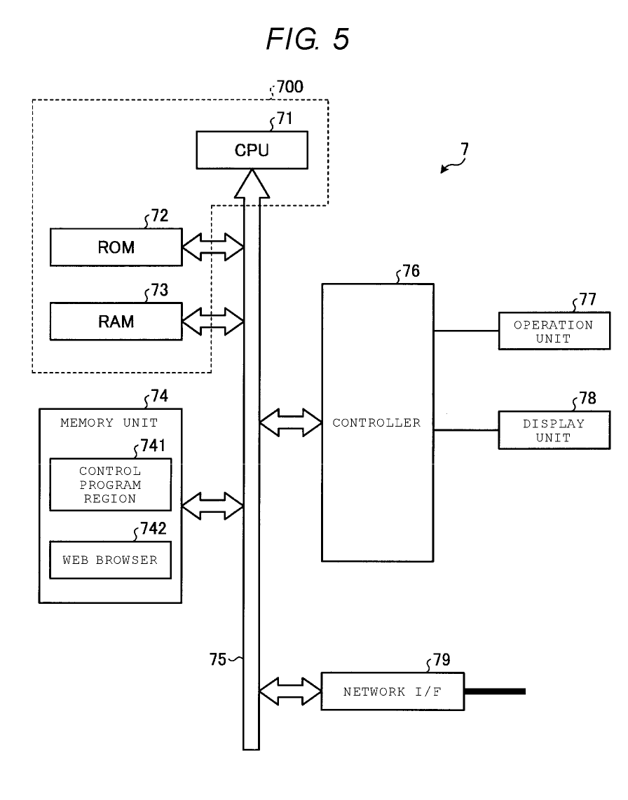

When the above-described membership registration is completed, the portable terminal 7 generates and stores a code symbol such as a bar code, a two-dimensional code, and the like including the member ID. In addition, the portable terminal 7 displays the code symbol on a display unit 78 (see FIG. 5).

The customer indicates the code symbol displayed on the portable terminal 7 to a salesclerk at the time of the transaction in the store P1. The salesclerk operates a reading unit 21 (see FIG. 2) of the POS terminal 1 that includes a scanner to read the code symbol displayed on the portable terminal 7 (see FIG. 2). Then, the POS terminal 1 generates the electronic receipt information based on the member ID included in the read code symbol and the transaction information.

The portable terminal 7 transmits the member ID to the electronic receipt management server 4 through the network N5. The electronic receipt management server 4 discloses the electronic receipt information associated with the received member ID on the Web to be viewable. The portable terminal 7 displays the disclosed electronic receipt information on the display unit 78. As a result, the customer can view the electronic receipt information displayed on the display unit 78 of the portable terminal 7.

Specifically, sales information generated through the transaction processing performed in the POS terminal 1 of the store P1 and the electronic receipt information indicating the payment information, is transmitted from the POS terminal 1 to the electronic receipt management server 4. The electronic receipt management server 4 discloses the electronic receipt information on the Web, in response to the view request from the portable terminal 7. The portable terminal 7 in which the web browser is installed displays the electronic receipt information disclosed on the Web by accessing URL. The customer can view the electronic receipt information displayed on the portable terminal 7 as the electronic receipt. By installing an application for viewing the electronic receipt information in the portable terminal 7, the electronic receipt may be viewed.

Next, an information terminal 8 is arranged in the store P1. The information terminal 8 is connected to the POS terminal 1 and the store server 2 through the network N1, and is a computer including a display unit and an operation unit. The information terminal 8 displays the information of merchandise and special sale information at the store P1 on a display unit thereof (not illustrated). Customers can obtain the special sale information of merchandise and also accumulated point information by operating the information terminal 8.

Next, a configuration of devices included in the electronic receipt system according to the present embodiment will be described.

First, the POS terminal 1, which is the information terminal device, will be described. FIG. 2 is a block diagram of the POS terminal 1. As illustrated in FIG. 2, the POS terminal 1 includes a central processing unit (CPU) 11, a read only memory (ROM) 12 for storing various programs, a random access memory (RAM) 13 for storing variety of data, a memory unit 14 for storing various programs, or the like. The CPU 11, the ROM 12, the RAM 13, and the memory unit 14 are connected to one another through a data bus 15. The CPU 11, the ROM 12, and the RAM 13 configure a control unit 100. That is, the control unit 100 performs control processing described below by an operation of the CPU 11 according to a control program stored in the memory unit 14 and developed to the RAM 13.

The memory unit 14 is a non-volatile memory such as a hard disc drive (HDD), a flash memory, and the like that maintains stored information even when turned off, and includes a control program region 141 for storing the control program. In addition, the memory unit 14 includes an issue count storage region 142 for storing the number of issue times of the electronic receipt, which is received from the electronic receipt management server 4.

In addition, the control unit 100 is connected to an operator display unit 17 and a customer display unit 18 including a liquid crystal display (LCD) or the like, an operation unit 19 including a key board or the like, and a printing unit 20 including a thermal printer or the like, and the reading unit 21, through the data bus 15 and a controller 16.

The reading unit 21 is a scanner device that optically reads the code symbol such as the bar code, the two-dimensional code, or the like. The code symbol is attached to the merchandise, or displayed on the portable terminal 7, or the like, and the control unit 100 obtains information held in the read code symbol. A merchandise code or the like for specifying merchandise is held in the code symbol attached to the merchandise. The member ID or the like for specifying the destination of the electronic receipt information is held in the code symbol displayed on the portable terminal 7. Alternatively, the member ID may be magnetically or electrically stored in the portable terminal 7. In this case, a dedicated reading device reads the stored member ID. The control unit 100 obtains the read member ID.

The controller 16 operates to displays images based on the display information on the operator display unit 17 and the customer display unit 18. In addition, the controller 16 receives input signals corresponding to keys that are operated on the operation unit 19. In addition, for example, the controller 16 controls the printing unit 20 to print a receipt based on the receipt information.

The control unit 100 is connectable to a communication interface (I/F) 22 through the data bus 15, and further to the network N1, the network N2, and the network N3 in the store through the communication I/F 22.

Next, the electronic receipt management server 4, which is the information processing device, will be described. FIG. 3 is a block diagram of the electronic receipt management server 4. As illustrated in FIG. 3, the electronic receipt management server 4 includes a CPU 41, a ROM 42 that stores various programs, a RAM 43 that stores variety of data, a memory unit 44 that stores various programs, and the like. The CPU 41, the ROM 42, the RAM 43, and the memory unit 44 are connected to one another through a data bus 45. The CPU 41, the ROM 42, and the RAM 43 configure a control unit 400. That is, the control unit 400 performs control processing described below by an operation of the CPU 41 according to a control program stored in the memory unit 44 and developed to the RAM 43.

The memory unit 44 is a non-volatile memory such as a HDD, a flash memory, and the like that maintains stored information even when turned off, and includes a control program region 441 for storing the control program. In addition, the memory unit 44 includes an electronic receipt region 442 for storing the electronic receipt information received from the POS terminal 1 and a reward information region 443 for storing information of reward to be granted to customers.

The reward information region 443 stores the information of the reward to be granted to customers according to the number of issue times of the electronic receipt. When the reward is discount of the total amount, a discount rate according to the number of issue times of electronic receipts is stored in the reward information region 442. For example, 5% is stored as the discount rate for the number of issue times greater than 50 times, 10% is stored as the discount rate for the number of issue times greater than 100 times, and 15% is stored as the discount rate for the number of issue times equal to or greater than 150 times. When the reward is reward points according to the number of issue times, for example, 50 points is stores as the reward points for the number of issue times greater than 50 times, 100 points is stored as the reward points for the number of issue times greater than 100 times, and 150 points are stored as the reward points for the number of issue times equal to or greater than 150 times.

In addition, the control unit 400 is connected to an operation unit 47 including a keyboard or the like, and a display unit 48 including an LCD or the like through a data bus 45 and a controller 46.

In addition, the control unit 400 is connected to the network N3 and the network N5 through the data bus 45 and a network I/F 49.

Subsequently, the electronic receipt region 442 provided in the memory unit 44 will be described. FIG. 4 illustrates a structure of the electronic receipt region 442. The electronic receipt region 442 is used to store the electronic receipt information received from the POS terminal 1 for each member ID.

The electronic receipt region 442 includes a member ID section 4421, a customer information section 4422, a destination information section 4423, the electronic receipt information section 4424, and the issue count section 4425. The member ID section 4421 is used to store the member ID of a member, which is information for specifying the destination. The customer information section 4422 is used to store various kinds of information of the member (name of member, age, address, attribute information, membership rank, or the like) associated with the member ID. The destination information section 4423 is used to store the destination information (for example, mail address) of the member associated with the member ID, to notify the presence or absence of the electronic receipt information. The electronic receipt information section 4424 stores the electronic receipt information to be displayed on the portable terminal 7. The issue count section 4425 stores the number of times the electronic receipt was issued with respect to the member associated with the member ID.

Next, the portable terminal 7 will be described. FIG. 5 is a block diagram of the portable terminal 7. As illustrated in FIG. 5, the portable terminal 7 includes a CPU 71, a ROM 72 that stores various programs, a RAM 73 that stores variety of data, a memory unit 74 that stores various programs, and the like. The CPU 71, the ROM 72, the RAM 73, and the memory unit 74 are connected to one another through the data bus 45. The CPU 71, the ROM 72, and the RAM 73 configure a control unit 700. That is, the control unit 700 performs control processing described below by an operation of the CPU 71 according to a control program stored in the memory unit 74 and developed to the RAM 73.

The memory unit 74 is a non-volatile memory such as a HDD, a flash memory, and the like that maintains stored information even when turned off, and includes a control program region 741 for storing the control program. In addition, the memory unit 74 stores a web browser 742.

The control unit 700 is connected to an operation unit 77 including a keyboard or the like, and a display unit 78 including an LCD or the like through a data bus 75 and a controller 76.

In addition, the control unit 700 is connected to the network N5 through the data bus 75 and a network I/F 79.

Hereinafter, processing of each device of the electronic receipt system according to the present embodiment will be described.

First, electronic receipt processing performed by the controlling of the control unit 100 of the POS terminal 1 according to a control program stored in the control program region 141 will be described.

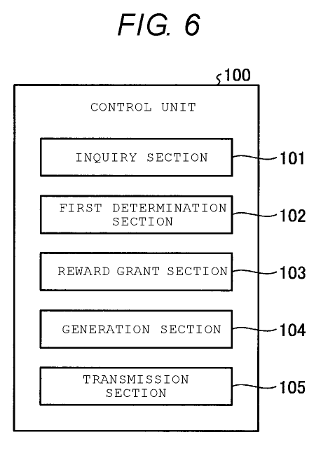

FIG. 6 illustrates functional sections of the POS terminal 1. The control unit 100 functions as an inquiry section 101, a first determination section 102, a reward grant section 103, a generation section 104, and a transmission section 105, by reading the control program from the control program region 141 and executing the control program.

The inquiry section 101 has a function for inquiring the number of times the electronic receipt associated with a member ID was issued, with respect to the electronic receipt management server 4 that counts the number of issue times for each member ID.

The first determination section 102 has a function of determining whether or not the number of issue times received from the electronic receipt management server 4 reached a predetermined number (multiple of 50 times), in response to the inquiry from the inquiry section 101.

The reward grant section 103 has a function of granting reward to the member associated with the member ID, when the first determination section 102 determines that the number of issue times reached the predetermined number.

The generation section 104 has a function of generating the electronic receipt information, based on the transaction processing.

The transmission section 105 has a function of transmitting the electronic receipt information generated by the generation section 104 to the electronic receipt management server 4.

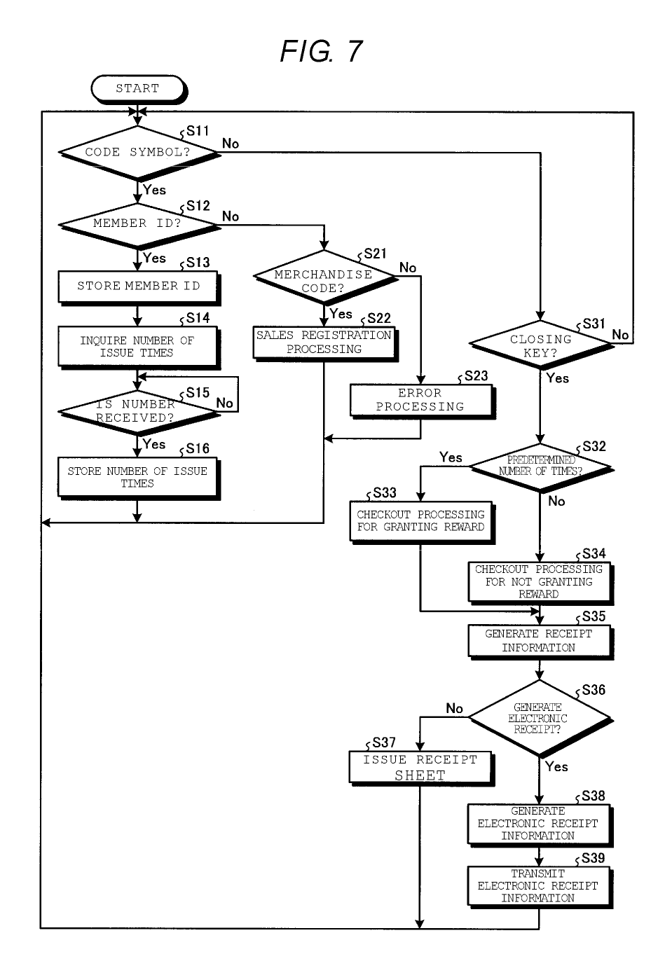

FIG. 7 is a flowchart illustrating the processing by the POS terminal 1. First, the control unit 100 of the POS terminal 1 determines whether or not the code symbol is read by the reading unit 21 (S11). When it is determined that the code symbol is read (Yes in S11), the control unit 100 determines whether or not the read code symbol includes a member ID (S12). When it is determined that the member ID is included (Yes in S12), the control unit 100 stores the read member ID in the RAM 13 (S13). Then, based on the stored member ID, the control unit 100 (inquiry section 101) inquires the number of times electronic receipts were issued to a customer associated with the member ID, with respect to the electronic receipt management server 4 (S14). Next, the control unit 100 determines whether or not a response from the electronic receipt management server 4 is received (S15). The control unit 100 waits until the response is received (No in S15). When it is determined that the response is received (Yes in S15), the control unit 100 stores the number of issue times in the issue count storage region 142 (S16). Thereafter, the process returns to S11.

When it is determined that no member ID is included in the code symbol read by the reading unit 21 (No in S12), the control unit 100 determines whether or not the merchandise code is included in the code symbol read by the reading unit 21 (S21). When it is determined that the merchandise code is included (Yes in S21), the control unit 100 performs the sales registration processing of the merchandise, based on the read merchandise code (S22). Then, the control unit 100 stores the merchandise information of the merchandise for which the sales registration processing was performed in the merchandise information unit 131. Thereafter, the process returns to S11. Meanwhile, when it is determined that the code symbol read by the reading unit 21 is not the merchandise code (No in S21), since the code symbol read in S11 is neither the member ID nor the merchandise code, the control unit 100 operates to display error information on the operator display unit 17 and the customer display unit 18 (S23). Thereafter, the process returns to S11.

Meanwhile, when it is determined that no code symbol is read in S11 (No in S11), the control unit 100 determines whether or not a closing key (not illustrated) provided in the operation unit 19 is operated (S31). The closing key is operated by an operator to complete one transaction with a customer. When it is determined that the closing key is operated (Yes in S31), the control unit 100 (first determination section 102) determines whether or not the number of issue times stored in the issue count storage region 142 in S16 reaches the predetermined number (S32). The predetermined number is stored in the issue count storage region 142, and the decision made in S32 is carried out by comparing the number of issue times in the memory unit 14 with the predetermined number. In the present embodiment, the predetermined number is multiples of 50, that is, 50, 100 . . . . When the number of issue times stored in the issue count storage region 142 reaches a multiple of 50, the control unit 100 determines that the number of issue times reached the predetermined number in S33.

When it is determined that the number of issue times reached the predetermined number (Yes in S32), the control unit 100 (reward grant section 103) performs checkout processing for granting reward with respect to the customer associated with the member ID stored in S13 (S33). For example, when the reward is discount of the total amount, the control unit 100 performs checkout processing of discounting a predetermined amount. When the reward is granting of reward points, the control unit 100 performs checkout processing of granting predetermined reward points. Meanwhile, when it is determined that the number of issue times does not reach the predetermined number (No in S32), the control unit 100 performs normal checkout processing of not granting the reward with respect to the customer associated with the member ID stored in S13 (S34).

After performing the checkout processing in S33 or S34, the control unit 100 (generation section 104) generates the receipt information, based on merchandise information of registered merchandise and payment information used in the checkout processing is performed (S35). Next, the control unit 100 determines whether or not the electronic receipt information is generated based on the receipt information (S36). When the member ID is stored in the RAM 13, the control unit 100 determines that the electronic receipt information is generated from the receipt information.

When it is determined that the electronic receipt information is generated from the receipt information (Yes in S36), the control unit 100 generates the electronic receipt information by converting a data format of the receipt information from a unstructured format to a structured format (S38). Then, the control unit 100 (transmission section 105) transmits the generated electronic receipt information to the electronic receipt management server 4 (S39). Thereafter, the process returns to S11. Meanwhile, when it is determined that no electronic receipt information is generated from the receipt information (No in S36), the control unit 100 controls the printing unit 20 to print the receipt information generated in S35 on a receipt sheet, by the printing unit 20, as a receipt (S37). Thereafter, the process returns to S11.

Next, electronic receipt processing performed by the control unit 400 of the electronic receipt management server 4 executing the control program stored in the control program region 441 will be described.

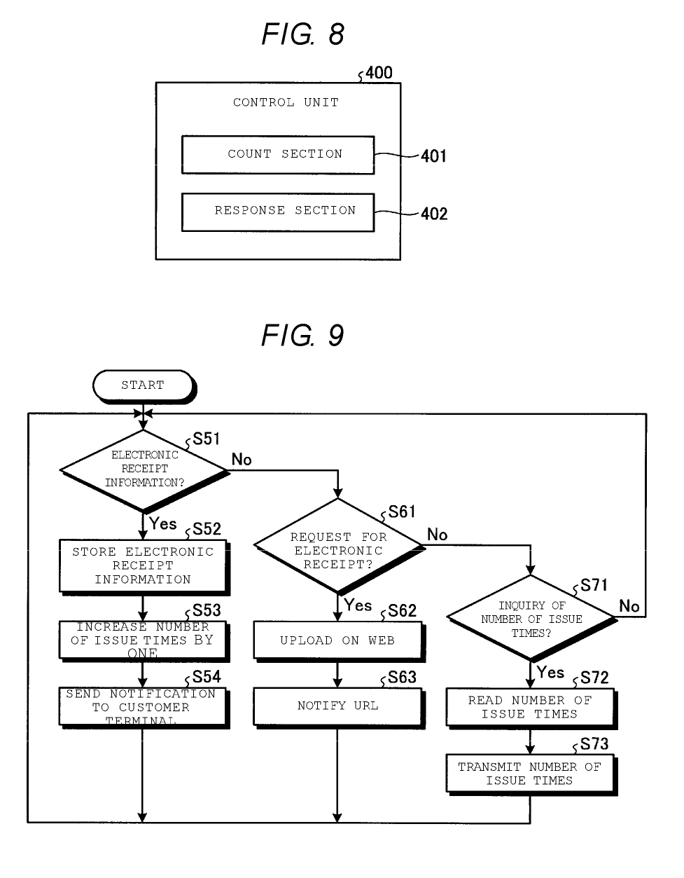

FIG. 8 illustrates functional sections of the electronic receipt management server 4. The control unit 400 functions as a count section 401 and a response section 402, by reading the control program from the control program region 441 and executing the control program.

The count section 401 has a function of counting the number of issue times of the electronic receipt for each member ID.

The response section 402 has a function of returning the number of issue times corresponding to a member ID counted by the count section 401 to the POS terminal 1, in response to an inquiry of the number of issue times from the POS terminal 1.

FIG. 9 is a flowchart illustrating a flow of control processing carried out by the electronic receipt management server 4. First, the control unit 400 of the electronic receipt management server 4 determines whether or not the electronic receipt information transmitted from the POS terminal 1 is received (S51). When it is determined that the electronic receipt information is received (Yes in S51), the control unit 400 stores the received electronic receipt information in association with the member ID that is received at the same time, in the electronic receipt information section 4424 of the electronic receipt region 442 (S52). Next, the control unit 400 (count section 401) counts up, by one, the number of issue times stored in the issue count section 4425 in association with the member ID (S53). That is, the control unit 400 counts, as the number of issue times of the electronic receipt, the number of units of the electronic receipt information received in S51. Then, the control unit 400 notifies that the electronic receipt information is received, with respect to the portable terminal 7 that has access to the destination specified in the member ID (S54). Thereafter, the process returns to S51.

A customer who operates the portable terminal 7 transmits the member ID to the electronic receipt management server 4 and requests the electronic receipt, by operating the portable terminal 7 that has received the notification, in order to view the electronic receipt.

In addition, when it is determined that no electronic receipt information is received from the POS terminal 1 in S51 (No in S51), the control unit 400 determines whether or not there is a request for the electronic receipt from the portable terminal 7 (S61). When it is determined that there is the request for the electronic receipt (Yes in S61), the control unit 400 uploads the electronic receipt information corresponding to the member ID received from the portable terminal 7 on the Web, so that the electronic receipt information is viewable using the portable terminal (S62). Then, the control unit 400 notifies the portable terminal 7 of URL indicating a view location (S63). Thereafter, the process returns to S51.

The portable terminal 7 displays the uploaded electronic receipt information on the display unit 78. In this manner, the customer who owns the portable terminal 7 can view the electronic receipt.

In addition, when it is determined that there is no request for the electronic receipt from the portable terminal 7 (No in S61), the control unit 400 determines whether or not there is an inquiry for the number of issue times of the electronic receipt from the POS terminal 1 (S71). When it is determined that there is the inquiry (Yes in S71), the control unit 400 reads the number of issue times stored in the issue count section 4425 of the electronic receipt region 442 in association with the member ID that was received at the same time (S72). Then, the control unit 400 (response section 402) transmits the number of issue times to the POS terminal 1 that has sent the inquiry (S73). Thereafter, the process returns to S51.

When it is determined that there is no inquiry for the number of issue times (No in S71), the process returns to S51.

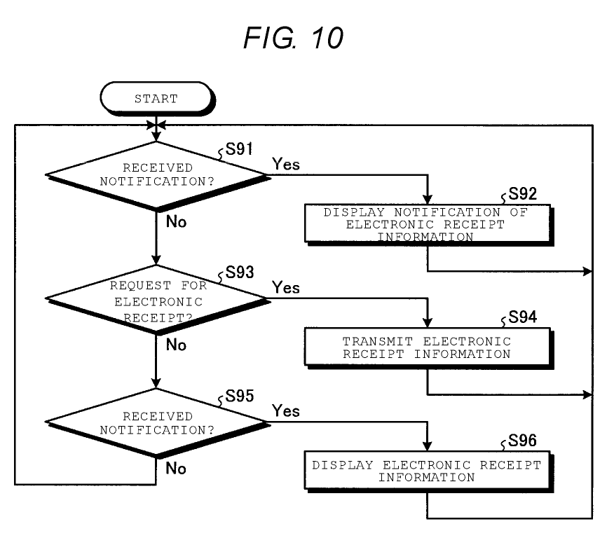

Next, processing carried out by the portable terminal 7 will be described. FIG. 10 is a flowchart illustrating a flow of the processing carried out by the portable terminal 7. First, the control unit 700 of the portable terminal 7 determines whether or not notification indicating the reception of the electronic receipt information is received from the electronic receipt management server 4 (S91). When it is determined that the notification is received (Yes in S91), the control unit 700 displays the notification on the display unit 78 (S92). For example, the notification is a message such as “Your electronic receipt has been received” or the like. Thereafter, the process returns to S91.

Meanwhile, when it is determined that no notification of the reception of the electronic receipt information is received (No in S91), the control unit 700 determines whether or not a customer operates the operation unit 77 and the electronic receipt information is requested (S93). When it is determined that the operation unit 77 is operated (Yes in S93), the control unit 700 transmits the member ID stored in the portable terminal 7 and the request for the electronic receipt information to the electronic receipt management server 4 (S94). Thereafter, the process returns to S91.

The electronic receipt management server 4 that received the request performs S61 to S63 of FIG. 9, so that the electronic receipt information corresponding to the member ID becomes viewable.

Meanwhile, when it is determined that no request for the electronic receipt information is received (No in S93), the control unit 700 determines whether or not notification including URL indicating a location of the electronic receipt information, is received from the electronic receipt management server 4 (S95). When it is determined that the notification is received (Yes in S95), the control unit 700 operates to display the notification on the display unit 78 (S96). Thereafter, the process returns to S91. The customer can view the electronic receipt displayed on the display unit 78 by accessing the URL attached to the notification. When it is determined that the electronic receipt information is not viewable (No in S95), the process returns to S51.

According to the first embodiment, when the member ID is input, the control unit 100 of the POS terminal 1 inquires the number of issue times of the electronic receipt issued with respect to the customers associated with the member ID. Then, when it is determined that the number of issue times received from the electronic receipt management server 4 reached a predetermined number, the control unit 100 grants reward with respect to the customer. With such a configuration, it is possible to provide a scheme for customer benefits using the electronic receipt system.

In addition, the control unit 400 of the electronic receipt management server 4 counts the number of issue times of the electronic receipt, and returns the counted number in response to the inquiry from the POS terminal 1. Since it is possible to grant reward corresponding to the number of issue times of the electronic receipt to customers, it is possible to provide a scheme for customer benefit using the electronic receipt system.

### Second Embodiment

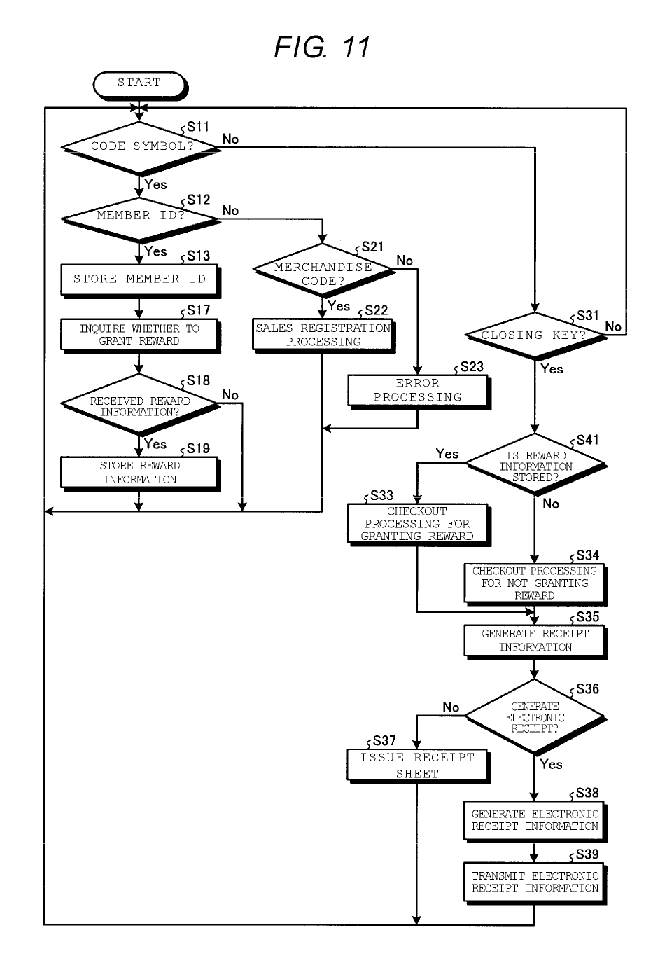

In a second embodiment, determination of whether or not the number of issue times of the electronic receipt reaches the predetermined number is performed by the electronic receipt management server 4. Hereinafter, the second embodiment will be described with reference to FIG. 11 to FIG. 13. In FIG. 11, the same processes as those of FIG. 7 are described with the same reference numerals, and description thereof is omitted. In addition, in FIG. 13, the same processes as those of FIG. are described with the same reference numerals, and description thereof is omitted.

First, the POS terminal 1 according to the second embodiment will be described. FIG. 11 is a flowchart illustrating a flow of control processing carried out by the POS terminal 1 according to the second embodiment. First, the control unit 100 inquires permission of the grant of reward with respect to the electronic receipt management server 4, based on the member ID stored in S13 (S17). Then, the control unit 100 determines whether or not reward information of the reward granted to the customer associated with the member ID is received from the electronic receipt management server 4 (S18). When it is determined that the reward information is received (Yes in S18), the control unit 100 operates to store the received reward information (S19). Thereafter, the process returns to S11. When it is determined that no reward information is received (No in S18), the process returns to S11.

When the closing key is operated (Yes in S31), the control unit 100 determines whether or not the reward information is stored in S19 (S41). When it is determined that the reward information is stored (Yes in S41), checkout processing for granting the reward is performed based on the reward information (S33). When it is determined that no reward information is stored (No in S41), the control unit 100 performs normal settlement processing so as to not grant the reward (S34).

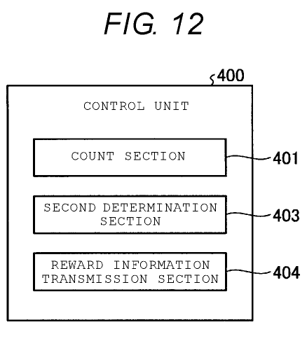

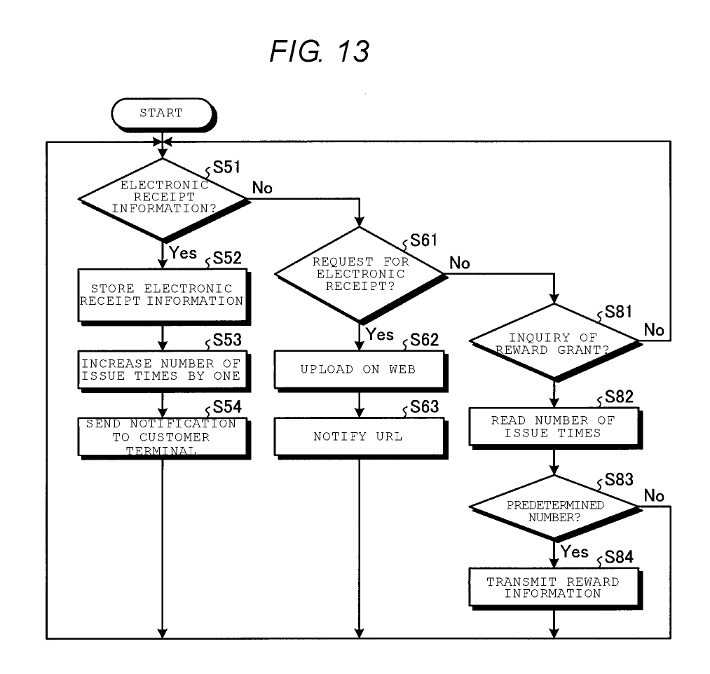

Next, processing carried out by the electronic receipt management server 4 according to the second embodiment will be described. FIG. 12 illustrates functional sections of the electronic receipt management server. The control unit 400 functions as the count section 401, a second determination section 403, and a reward information transmission section 404, by reading the control program from the control program region 441 and executing the control program.

The count section 401 has a function of counting the number of issue times of the electronic receipt for each member ID.

The second determination section 403 has a function of determining whether or not the number of issue times counted by the count section 401 reached a predetermined number.

The reward information transmission section 404 has a function of transmitting reward information of granting the reward to a member associated with the member ID to the POS terminal 1, with respect to the inquiry of the reward grant from the POS terminal 1, when the second determination section 403 determines that the number of issue times reached the predetermined number.

FIG. 13 is a flowchart illustrating a flow of the processing carried out by the electronic receipt management server according to the second embodiment. In FIG. 13, when it is determined that there is no request for the electronic receipt (No in S61), the control unit 400 determines whether or not there is an inquiry for granting the reward from the POS terminal 1 (S81). When it is determined that there is the inquiry (Yes in S81), the control unit 400 reads the number of issue times of the electronic receipt stored in the issue count section 4425 of the electronic receipt unit 442, based on the member ID that was received at the same time (S82). Then, the control unit 400 (second determination section 403) determines whether or not the read number of issue times reached a predetermined number (S83). When it is determined that the read number reached the predetermined number (Yes in S83), the control unit 400 (reward information transmission section 404) transmits the reward information stored in the memory unit 44 to the POS terminal 1 (S84). Thereafter, the process returns to S51. Meanwhile, when it is determined that the number of issue times has not reached the predetermined number (No in S83), the process returns to S51. In addition, when it is determined that there is no inquiry of the reward grant (No in S81), the process returns to S51.

As described above, according to the second embodiment, the control unit 400 of the electronic receipt management server 4 determines whether or not the number of issue times of the electronic receipt reached the predetermined number of times in response to the inquiry from the POS terminal 1, and when the control unit 400 determines that the number of issue times reached the predetermined number, the control unit 400 transmits the reward information to the POS terminal 1. Since it is possible to grant reward to customers according to the number of issue times of the electronic receipts, it is possible to provide a scheme for customer benefits, using the electronic receipt system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the above embodiments, the electronic receipt management server 4 sets the number of times the electronic receipt information transmitted from the POS terminal 1 and received thereby as the number of issue times of the electronic receipt. However, the present disclosure is not limited thereto. For example, the electronic receipt management server 4 may set the number of times the electronic receipt information becomes viewable on the portable terminal 7 by being uploaded on the Web as the number of issue times of the electronic receipt. In this case, the control unit 400 counts the number of times the information of the electronic receipt uploaded on the Web in S62 as the number of issue times of the electronic receipt.

In addition, in the above embodiments, the reward is discount of the total amount (by a predetermined percentage) or grant of points. However, the present disclosure is not limited thereto. The reward may be discount of the total amount by a predetermined amount or a gift.

In addition, in the above embodiments, the POS terminal 1 is described as the information terminal device. However, the present disclosure is not limited thereto. For example, the information terminal 8 that is located in the store and with which customers can obtain various kinds of information as the information terminal device.

In addition, in the above embodiments, when the number of issue times of the electronic receipt is multiples of 50, it is determined that the number of issue times reached the predetermined number. However, the present disclosure is not limited thereto. When the number of issue times exceeded the predetermined number, the number of issue times may be determined to have reached the predetermined number.

In addition, in the above embodiments, merchandise is described as the sales target. However, the present disclosure is not limited thereto. The sales target may be, for example, service provided to customers or the like.

In addition, in the above embodiments, the electronic receipt management server 4 causes the electronic receipt to be viewable by the portable terminal 7, in response to a request from the portable terminal 7. The present disclosure is not limited thereto. The electronic receipt management server 4 may transmit the electronic receipt with respect to the portable terminal 7 associated with a specific address (information for specifying destination). In this case, when there is a transmission request of the electronic receipt from the portable terminal 7, the control unit 400 operates to transmit an e-mail to including the electronic receipt to the portable terminal 7. That is, the electronic receipt management server 4 sends the electronic receipt to the portable terminal 7. The portable terminal 7 that received the e-mail displays the electronic receipt attached to the e-mail on the display unit 78. Then, the control unit 400 counts the number of times the electronic receipts are transmitted from the electronic receipt management server 4 to the portable terminal 7 as the number of issue times of the electronic receipt.

The electronic receipt system according to an embodiment includes the POS terminal 1 and the electronic receipt management server 4. The electronic receipt management server 4 includes a count section that counts the number of times the electronic receipts are issued for each member ID. The POS terminal 1 includes a reward grant section that grants reward to a customer associated with the member ID for which the number of issue times of the electronic receipt reached a predetermined number. Furthermore, the electronic receipt system includes a determination section that determines whether or not the number of issue times of the electronic receipt reached the predetermined number.

What is claimed is:

1. A point-of-sale (POS) terminal, comprising:
a code reader;
a communication interface;
a memory device;
a control panel; and
a processor configured to
control the communication interface to transmit a customer code read from a customer's medium by the code reader to an electronic receipt server,
store, in the memory device, a number of times electronic receipts have been issued in association with the customer code, the number of times being provided by the electronic receipt server to the communication interface,
store, in the memory device, transaction details based on one or more product codes read by the code reader,
determine whether or not a sales promotion with respect to a transaction is offered to the customer based on the number of times stored in the memory device, in response to a user input to complete the transaction on the control panel, and
generate receipt information based on the transaction detail stored in the memory device and the offered sales promotion, if any.

2. The POS terminal according to claim 1, wherein
the processor determines that a sales promotion is to be offered when the number of times stored in the memory device is greater than a predetermined value.

3. The POS terminal according to claim 1, wherein
the processor determines that a first sales promotion is to be offered when the number of times stored in the memory device is greater than a first predetermined value, and a second sales promotion different from the first sales promotion is to be offered when the number of times stored in the memory device is greater than a second predetermined value that is greater than the first predetermined value.

4. An electronic receipt server, comprising:
a communication interface;
a memory device; and
a processor configured to
store, in the memory device, an electronic receipt in association with a customer code, when the communication interface receives the electronic receipt along with the customer code,
increment, in an entry of a customer table associated with the customer code, a number of times electronic receipts have been issued in association with the customer code, when the communication interface receives the electronic receipt along with the customer code, and
in response to an inquiry that includes the customer code, control the communication interface to return the number of times.

5. The electronic receipt server according to claim 4, wherein
the processor is further configured to make the electronic receipt associated with the customer code web-accessible, upon the communication interface receiving the electronic receipt along with the customer code, and
the number of times is incremented, in response to the electronic receipt being made web-accessible.

6. The electronic receipt server according to claim 4, wherein
the processor is further configured to control the communication interface to transmit the electronic receipt in response to an inquiry from a user terminal associated with the customer code, and
the number of times is incremented, in response to the electronic receipt being transmitted to the user terminal.

7. An electronic receipt server, comprising:
a communication interface;
a memory device; and
a processor configured to
store, in the memory device, an electronic receipt in association with a customer code, when the communication interface receives the electronic receipt along with the customer code,
increment, in an entry of a customer table associated with a customer code, a number of times electronic receipts have been issued in association with the customer code, when the communication interface receives the electronic receipt along with the customer code,
in response to an inquiry that includes the customer code, determine whether or not a sales promotion is to be offered to a customer associated with the customer code, based on the number of times stored in the memory device in association with the customer code, and control the communication interface to return a determination result.

8. The electronic receipt server according to claim 7, wherein
the processor determines that a sales promotion is to be offered when the number of times stored in the memory device is greater than a predetermined value.

9. The electronic receipt server according to claim 7, wherein
the processor determines that a first sales promotion is to be offered when the number of times stored in the memory device is greater than a first predetermined value, and a second sales promotion different from the first sales promotion is to be offered when the number of times stored in the memory device is greater than a second predetermined value that is greater than the first predetermined value.

10. The electronic receipt server according to claim 7, wherein
the processor is further configured to make the electronic receipt associated with the customer code web-accessible, when the communication interface receives the electronic receipt along with the customer code, and
the number of times is incremented, in response to the electronic receipt being made web-accessible.

11. The electronic receipt server according to claim 7, wherein
the processor is further configured to control the communication interface to transmit the electronic receipt in response to an inquiry from a user terminal associated with the customer code, and
the number of times is incremented, in response to the electronic receipt being transmitted to the user terminal.
